(19) United States
(12) Patent Application Publication
(10) Pub. No.: US 2026/0340405 A1
(43) Pub. Date: Oct. 29, 2026

(54) First Node, Computer System, Second Node and Method Performed Thereby, for Handling Reinforcement Learning in a Computer System

(71) Applicant: Telefonaktiebolaget LM Ericsson (publ), Stockholm (SE)

(72) Inventors: Perepu Satheesh Kumar, Chennai (IN); Saravanan M, Chennai (IN); Kaushik Dey, Kolkata (IN)

(21) Appl. No.: 19/124,386

(22) PCT Filed: Nov. 7, 2022
(86) PCT No.: PCT/IN2022/050973

§ 371 Date: Apr. 25, 2025

(51) Int. Cl. G06N 3/092

(52) U.S. Cl. CPC G06N 3/092

(57) ABSTRACT

A computer-implemented method performed by a first node (111). The first node (111) may have a capability to perform reinforcement learning in coordination with one or more additional nodes (112,113). The methods is for handling the reinforcement learning in a computer system (100). The first node (111) determines, in a reinforcement learning procedure, whether or not to perform an action, in response to a state in an environment, at a time of execution. The time of execution is determined dynamically. The first node (111) also initiates (203) outputting a first indication of a result of the determination.

### TECHNICAL FIELD

The present disclosure relates generally to a first node and methods performed thereby for handling reinforcement learning (RL) in a computer system. The present disclosure further relates generally to the computer system and methods performed thereby, for handling the RL in a computer system. The present disclosure further relates generally to the second node and methods performed thereby, for handling the RL in the computer system.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

Computer systems may be comprised in a telecommunications network. The telecommunications network may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

In the course of operations of the telecommunications network, data may be collected on the performance of the telecommunications network, which may enable to monitor and manage the malfunctioning of any of its elements.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected, and enable an improved management of the operation of the telecommunications network.

### Machine Learning (ML)

Machine learning (ML) may be understood as the study of computer algorithms that may improve automatically through experience. It is seen as a part of Artificial Intelligence (AI). Machine learning algorithms may build a model based on sample data, known as “training data”, in order to make predictions or decisions without being explicitly programmed to do so. Machine learning algorithms may be used in a wide variety of applications, such as email filtering and computer vision, where it may be difficult or unfeasible to develop conventional algorithms to perform the needed tasks.

There may be basically 3 types of Machine Learning Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), and Agglomerative Hierarchical Clustering.

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and machine learning.

Using the RL algorithm, a machine may be trained to make specific decisions. It may be understood to work as follows: the machine may be exposed to an environment where it may train itself continually using trial and error. This machine may learn from past experience and may try to capture the best possible knowledge to make accurate business decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches or value-based learning such as deep-q networks.

RL has been described thus far as a single agent RL. In some cases, it may be of interest to solve problems involving multiple agents, which may collaborate to achieve a common goal. For example, in some scenarios, it may be of interest to solve problems involving multiple individual objects. These multiple objects may interact with each other and achieve a common goal which may be represented by a multi-agent architecture. Multi-agent RL (MARL) is becoming increasingly popular to establish collaboration between multiple agents though suitable actions. MARL methods may be understood to be used to train the collaboration between agents without a requirement of an underlying model.

In MARL, a plurality of agents may interact with the environment and take joint action. The joint action may be applied onto the environment and models may be trained based on collective performance of all the agents. The collective performance may be measured based on the total reward of the system.

A value function decomposition may be used for scaling up MARL in cooperative operation between real or virtual objects. In a value decomposition method, the agents may be trained with the sum of individual value functions. Although value decomposition methods for cooperative MARL have great promise for addressing coordination problems in a variety of applications, theoretical understandings for these approaches are still limited.

Q-learning may be understood to be one of the most classical approaches to solving Markov decision processes in single agent RL. In MARL, applying an effective Q-learning based method is no longer straight forward. The agents may learn their local value functions with Q-learning by combining them monotonically to form the joint value function estimate. Its purpose may be understood to be to describe the settings in which these value function algorithms may be employed and settle their properties in these settings.

There are many multi-agent reinforcement techniques such as Value Decomposition Network (VDN), IQL, QMIX, MAVEN etc. All these techniques may be understood to assume that the agents took joint action. In some methods, all agents may take synchronous action [1]. In other methods, agents may take asynchronous actions, that is, each of the agents may act at its own time instant [2][3]. The taking of an action may be understood to be an actuation.

In spite of the advantages of using MARL, existing MARL methods may still result in overall performance degradation, or in wear of the hardware in the objects performing the actuations.

### SUMMARY

As part of the development of embodiments herein, one or more problems with the existing technology will first be identified and discussed.

In existing MARL methods, regardless of whether actions may be synchronous or asynchronous, agents perform actuations at fixed time steps. A number of issues arise when steps of fixed time are used for actuations. An issue that may arise whenever the agents perform actuations at a fixed time step is that, if the time between actuations is long, it is challenging to address any events happening during the time between actuations, and this may result in overall performance degradation. Another issue that may arise when the time between actuations is short is that, since the actions may be understood to be performed on the environment with hardware, frequent actions may increase the wear and tear of the hardware. Hence, independently of whether the time between actuations is long or short, the performance of the overall agents using existing methods will degrade, either due to hardware degradation or, due to the agents not having seen the sub-states which may emerge when the time-step duration is lengthened.

A further problem with existing methods is that agents may perform actions using the same time step they used during training. However, in many situations, agents may be required to take actions at different time steps during execution than those of time steps that may have been learnt during training. To explain this limitation with an example, a scenario may be considered wherein two objects A and B are trying to control the behavior of a third object C. The two objects A and B may be trained using RL agents. Object C may perform moves stochastically. That is, its speed may change with time. During training, the agents may be trained to take action every 1 minute, which is a fixed time. The training agents may learn to co-ordinate every 1 minute and decide to take the best action. However, ideally the agents may have to understand the movement of objects which may be targets of the actions and based on that, take action. For example, if object C moves fast, the agents may have to perform action frequently, at less than one minute intervals, whereas if object C moves slower, the agents may be able to perform actions less frequently. Taking actions with different time during execution may improve the overall efficiency of the process, as the actions may happen, in the example just provided, based on movement of object C.

It is therefore an object of embodiments herein to improve handling of RL in a computer system.

According to a first aspect of embodiments herein, the object is achieved by a computer-implemented method, performed by a first node. The first node has a capability to perform RL in coordination with one or more additional nodes. The method is for handling the RL in the computer system. The first node determines, in an RL procedure, whether or not to perform an action, in response to a state in an environment, at a time of execution. The time of execution is determined dynamically. The first node then initiates outputting a first indication of a result of the determination.

According to a second aspect of embodiments herein, the object is achieved by a computer-implemented method, performed by the computer system. The computer system comprises the first node and the one or more additional nodes. The first node and the one or more additional nodes have the capability to perform RL in coordination. The method is for handling the RL in the computer system. The computer system determines, by each of the first node and the one or more additional nodes, in the RL procedure, whether or not to perform a respective action, in response to a respective state in the environment, at a respective time of execution. The respective time of execution is determined dynamically. The computer system then initiates, by each of the first node and the one or more additional nodes outputting a respective first indication of a respective result of the determination.

According to a third aspect of embodiments herein, the object is achieved by a computer-implemented method, performed by a second node. The method is for handling the RL in the computer system. The computer system comprises the first node and the one or more additional nodes. The first node and the one or more additional nodes have the capability to perform RL in coordination. The second node receives, from each of the first node and the one or more additional nodes, in the reinforcement learning procedure, the respective first indication. The respective first indication indicates a computed respective value function in the reinforcement learning, to perform the respective action, in response to the respective state in the environment, at the respective time of execution. The respective time of execution is determined dynamically by each of the first node and the one or more additional nodes. The second node determines, based on the received respective first indications, a combined value function in the reinforcement learning procedure for the first node and the one or more additional nodes.

According to a fourth aspect of embodiments herein, the object is achieved by the first node. The first node is configured to have the capability to perform reinforcement learning in coordination with the one or more additional nodes. The first node is configured to be for handling the reinforcement learning in the computer system. The first node is further configured to determine, in the RL, whether or not to perform an action, in response to the state in the environment, at the time of execution. The time of execution is configured to be determined dynamically. The first node is also configured to initiate outputting the first indication of the result of the determination.

According to a fifth aspect of embodiments herein, the object is achieved by the computer system. The computer system is configured to comprise the first node and the one or more additional nodes. The first node and the one or more additional nodes may be configured to have the capability to perform reinforcement learning in coordination. The computer system is configured to be for handling the reinforcement learning in the computer system. The computer system is further configured to determine, by each of the first node and the one or more additional nodes, in the reinforcement learning procedure, whether or not to perform the respective action, in response to the respective state in the environment, at the respective time of execution. The respective time of execution is configured to be determined dynamically. The computer system is also configured to initiate, by each of the first node and the one or more additional nodes, outputting the respective first indication configured to indicate the respective result of the respective determination.

According to a sixth aspect of embodiments herein, the object is achieved by the second node. The second node may be understood to be for handling the reinforcement learning in the computer system. The computer system is configured to comprise the first node and the one or more additional nodes. The first node and the one or more additional nodes may have the capability to perform reinforcement learning in coordination. The second node is configured to receive, from each of the first node and the one or more additional nodes, in the reinforcement learning procedure, the respective first indication. The respective first indication may be configured to indicate the computed respective value function in the reinforcement learning, to perform the respective action, in response to the respective state in the environment, at the respective time of execution. The respective time of execution may be configured to be determined dynamically by each of the first node and the one or more additional nodes. The second node is also configured to determine, based on the received respective first indications, the combined value function in the reinforcement learning procedure for the first node and the one or more additional nodes.

Embodiments herein may result in efficient and more generalized agents that may execute in different time steps.

In many cases, as explained earlier, it may be beneficial to perform only event-based actuations. By performing the determination of whether or not to perform an action with the dynamically determined time or execution, the first node may enable to perform event-based actuations. That is, actuations if and only if some change happens. This may be understood to be in contrast to existing methods, which may assume the execution time-step may be the same time-step as that used during training.

By initiating outputting the first indication, the first node may then be enabled to trigger event-based actuations, to ensure the first node may behave optimally and take actions when it may have good state information. Since the first node may perform RL in coordination with the one or more additional nodes, by initiating outputting the first indication, the first node may also enable to trigger event-based actuations, to ensure the first node in coordination with the one or more additional nodes, may behave optimally and take actions when they may have accurate state information.

To illustrate this with an example, a scenario may be considered where a set of MARL agents which may control driver-less vehicles may be trained. These vehicles may measure state information from the network, such as information on nearby vehicles, and use these states to decide on the action to take. The network Quality of Service (QoS) may change depending on the number of nearby vehicles, network capacity etc. When the network QoS decreases, it may result in a significant packet loss due to network congestion. If the agents were trained with fixed time actuations, as they would in existing methods, it may hinder the execution performance between the agents, as the agents may need to take a decision when they may have predicted degradation of QoS, not when it may actually happen, due to the time-step resolution. When the MARL may train with fixed time actuations, the performance of the agents may not be optimal and/or agents may miss good state information. Embodiments herein may relate to a MARL system which may take event-based actuations to ensure the agents may behave optimally and take actions when they may have good state information.

Embodiments herein may also advantageously result in an increased life of the hardware, as actions may be understood to not be fixed in time.

The same advantages may be understood to be achieved by the computer system comprising the first node and the one or more additional nodes.

By the second node receiving the respective first indications, it may then be enabled to determine, based on the received respective first indications, the combined value function in the reinforcement learning for the first node and the one or more additional nodes. As this may result in an action being performed, or not, the second node may enable to perform event-based actuations, to ensure the first node in coordination with the one or more additional nodes, may behave optimally and take actions when they may have good state information, since the respective first indications may be configured to indicate the computed respective value function in the reinforcement learning, to perform the respective action, in response to the respective state in the environment, at the respective time of execution, which is dynamically determined.

### BRIEF DESCRIPTION OF THE DRAWINGS

Examples of embodiments herein are described in more detail with reference to the accompanying drawings, according to the following description.

FIG. 1 is a schematic diagram illustrating two non-limiting examples of a computer system, according to embodiments herein.

FIG. 2 is a flowchart depicting a method in a first node, according to embodiments herein.

FIG. 3 is a flowchart depicting a method in a computer system, according to embodiments herein.

FIG. 4 is a flowchart depicting a method in a second node, according to embodiments herein.

FIG. 5 is a schematic diagram depicting particular aspects of a non-limiting example of the method performed by the first node, according to embodiments herein.

FIG. 6 is a schematic block diagram illustrating embodiments of a first node, according to embodiments herein.

FIG. 7 is a schematic block diagram illustrating embodiments of a computer system, according to embodiments herein.

FIG. 8 is a schematic block diagram illustrating embodiments of a second node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein relate to an enterprise where multi-agents may be involved to perform actions in a collective manner.

Embodiments herein may take advantage of the speed, low latency and capacity to push AI, machine learning, real-time analytics and other advancements of, e.g., an enterprise Fifth Generation (5G) system, so that time-based execution of tasks may reach maximum QoS.

Particularly, embodiments herein may relate to ensuring that agents in a MARL may take actions at any different time scale during execution that that used during training, in order to improve QoS parameters in different environments. Embodiments herein may be understood to relate to a methodology to execute MARL, to perform actuations which may be understood to be event-based. This may be understood to be in contrast to existing methods, wherein the Q-value, which may be used to estimate how good taking an action may be given a certain state, does not take time into consideration and hence, cannot perform event-based actuations.

While time is not a parameter in the MDP, embodiments herein may also relate to considering the duration between time steps, which may be important for the granularity of observations, in order to improve QoS parameters in different environments.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

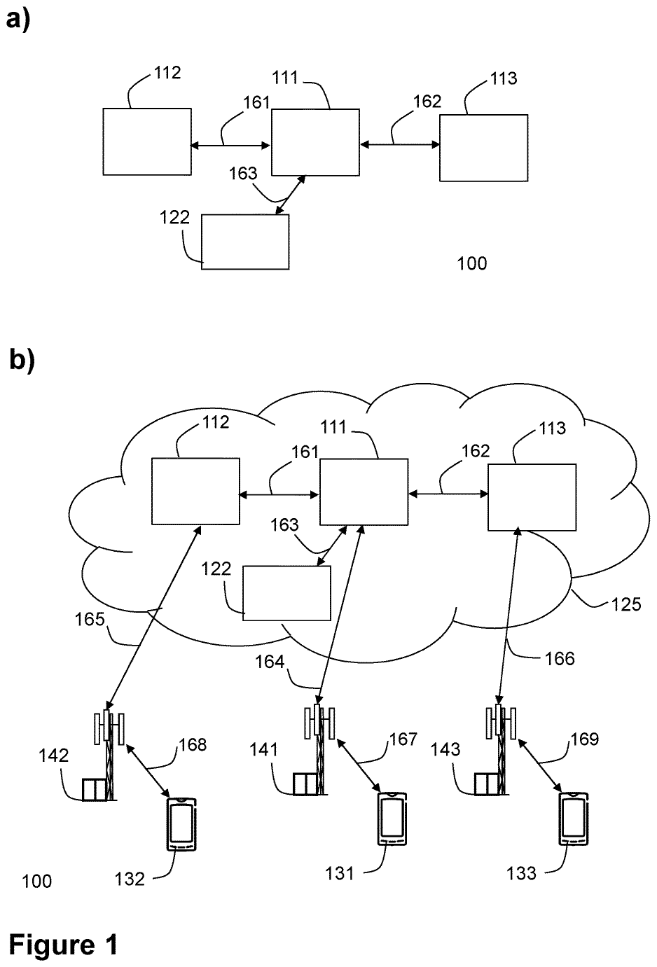

FIG. 1 depicts two non-limiting examples, in panels “a” and “b”, respectively, of a computer system 100, in which embodiments herein may be implemented. In some example implementations, such as that depicted in the non-limiting example of FIG. 1a), the computer system 100 may be a computer network. In other example implementations, such as that depicted in the non-limiting example of FIG. 1b), the computer system 100 may be implemented in a telecommunications system, sometimes also referred to as a cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or Next Gen network or an Internet service provider (ISP)-oriented network. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

The computer system 100 comprises a plurality of nodes, whereof a first node 111, one or more additional nodes 112, 113 and a second node 122 are depicted in FIG. 1. In the non-limiting example of FIG. 1, the one or more additional nodes comprise a first additional node 112, and a second additional node 113. However, it may be understood that this is for illustrative purposes only, and that the one or more additional nodes 112, 113 may comprise fewer or further additional nodes in other examples. Any of the first node 111, the one or more additional nodes 112, 113 and the second node 122 may be understood, respectively, as a first computer system or server, one or more additional computer systems or servers and a second additional computer system or server. Any of the first node 111, the one or more additional nodes 112, 113 and the second node 122 may be implemented as a standalone server in e.g., a host computer in the cloud 125, as depicted in the non-limiting example of FIG. 1b). In other examples, any of the first node 111, the one or more additional nodes 112, 113 and the second node 122 may be a distributed node or distributed server, such as a virtual node in the cloud 125, and may perform some of its respective functions locally, e.g., by a client manager, and some of its functions in the cloud 125, by e.g., a server manager. In other examples, any of the first node 111, the one or more additional nodes 112, 113 and the second node 122 may perform its functions entirely on the cloud 125, or partially, in collaboration or collocated with a radio network node. Yet in other examples, any of the first node 111, the one or more additional nodes 112, 113 and the second node 122 may also be implemented as processing resources in a server farm. Any of the first node 111, the one or more additional nodes 112, 113 and the second node 122 may be under the ownership or control of a service provider or may be operated by the service provider or on behalf of the service provider.

Any of the first node 111, and one or more additional nodes 112, 113 may be understood to have a capability to perform machine-implemented learning procedures, which may be also referred to as “machine learning”, particularly, RL. Further particularly, the first node 111 and the one or more additional nodes 112,113 may be understood to have a capability to perform RL in coordination. The RL in coordination with one or more additional nodes 112,113 may be understood to be a multi-agent RL procedure. The RL procedure may use one of: a QMIX procedure, an Implicit Q-Learning procedure, a Multi-Agent Variational Exploration (MAVEN) procedure, a Value Decomposition Network (VDN). Each of the first node 111 and the one or more additional nodes 112,113 may be represented by a three layer recurrent neural network (RNN).

In some embodiments, any of the first node 111, the one or more additional nodes 112, 113 and the second node 122 may be a core network node, such as, e.g., a network data analytics function (NWDAF), a Serving General Packet Radio Service Support Node (SGSN), a Mobility Management Entity (MME), a positioning node, a coordinating node, a Self-Optimizing/Organizing Network (SON) node, a Minimization of Drive Test (MDT) node, etc. . . . . In 5G, for example, any of the first node 111, the one or more additional nodes 112, 113 and the second node 122 may be located in the OSS (Operations Support Systems). In embodiments wherein, any of the first node 111, the one or more additional nodes 112, 113 and the second node 122 may be core network nodes, such as in the non-limiting example of panel b) in FIG. 1, any of the first node 111, the one or more additional nodes 112, 113 and the second node 122 may communicate, respectively, with one or more radio network nodes. In the non-limiting example of panel b) in FIG. 1, and for illustration purposes only, the first node 111 is in communication with a first radio network node 141, the first additional node 112 is in communication with a second radio network node 142, and the second additional node 113 is in communication with a third radio network node 143. It may be understood that the second node 122 may be in communication with another radio network node. Furthermore, any of the first node 111, the one or more additional nodes 112, 113 and the second node 122 may be in communication with more than one radio network node.

In other examples not depicted in FIG. 1, any of the first node 111, the one or more additional nodes 112, 113 and the second node 122 may be a radio network node.

A radio network node may be, e.g., comprised in a Radio Access Network of the telecommunications system. That is, the radio network node may be a transmission point such as a radio base station, for example a gNB, an eNB, or any other network node with similar features capable of serving a wireless device, such as a user equipment or a machine type communication device, in the computer system 100. In typical examples, the radio network node may be a base station, such as a gNB. In other examples, the radio network node may be a distributed node, such as a virtual node in the cloud 125, and may perform its functions entirely on the cloud 125, or partially, in collaboration with a radio network node.

The telecommunications system may cover a geographical area, which in some embodiments may be divided into cell areas, wherein each cell area may be served by a radio network node, although, one radio network node may serve one or several cells. In the example of FIG. 1, the cells are not depicted to simplify the figure. The network node may be of different classes, such as, e.g., macro eNodeB, home eNodeB or pico base station, based on transmission power and thereby also cell size. In some examples, the network node may serve receiving nodes with serving beams.

Any of the first node 111, the one or more additional nodes 112, 113 and the second node 122, e.g., as radio network node, or any of the radio network nodes 141, 142, 143 comprised in the computer system 100 may support one or several communication technologies, and its name may depend on the technology and terminology used. Any of the radio network nodes that may be comprised in the computer system 100 may be directly connected to one or more core networks.

A plurality of wireless devices may be comprised in the wireless communication network 100, whereof a first wireless device 131, a second wireless device 132 and a third wireless device 133 are depicted in the non-limiting examples of FIG. 1. This may be understood to be non-limiting and for illustrative purposes only. Further or fewer wireless devices may be comprised in the computer system 100. Any wireless device comprised in the wireless computer system 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the wireless devices comprised in the computer system 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any wireless device comprised in the computer system 100 is enabled to communicate wirelessly in the computer system 100. The communication may be performed e.g., via a RAN, and possibly the one or more core networks, which may be comprised within the wireless computer system 100.

As depicted in the non-limiting example of panel b) of FIG. 1, in examples wherein any of the first node 111, the one or more additional nodes 112, 113 and the second node 122 may be core network nodes, any of the first node 111, the one or more additional nodes 112, 113 and the second node 122 may be located in the cloud 125 and communicate with one or more wireless devices via a respective radio network node. In the particular non-limiting example of panel b) in FIG. 1, the first node 111 communicates with the first wireless device 131 via the first radio network node 141, the first additional node 112 communicates with the second wireless device 132 via the second radio network node 142 and the second additional node 143 communicates with the third wireless device 133 via the third radio network node 143.

The first node 111 may be configured to communicate within the computer system 100 with the first additional node 112 over a first link 161, e.g., a radio link. or a wired link. The first node 111 may be configured to communicate within the computer system 100 with the second additional node 113 over a second link 162, e.g., a radio link. or a wired link. The first node 111 may be configured to communicate within the computer system 100 with the second node 122 over a third link 163, e.g., a radio link. or a wired link. The first node 111 may be configured to communicate within the computer system 100 with the first radio network node 141 over a fourth link 164, e.g., a radio link. or a wired link. The first additional node 112 may be configured to communicate within the computer system 100 with the second radio network node 142 over a fifth link 165, e.g., a radio link. or a wired link. The second additional node 113 may be configured to communicate within the computer system 100 with the third radio network node 143 over a sixth link 166, e.g., a radio link. or a wired link. The first radio network node 141 may be configured to communicate within the computer system 100 with the first wireless device 131 over a seventh link 167, e.g., a radio link. or a wired link. The second radio network node 142 may be configured to communicate within the computer system 100 with the second wireless device 132 over an eighth link 168, e.g., a radio link. or a wired link. The third radio network node 143 may be configured to communicate within the computer system 100 with the third wireless device 133 over a ninth link 169, e.g., a radio link or a wired link.

Any of the links described in the previous paragraph may be a direct link or may be comprised of a plurality of individual links, wherein it may go via one or more computer systems or one or more core networks in the computer system 100, which are not depicted in FIG. 1, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

In general, the usage of “first”, “second”, “third”, “fourth”, “fifth”, “sixth”, “seventh”, “eighth” and/or “ninth” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

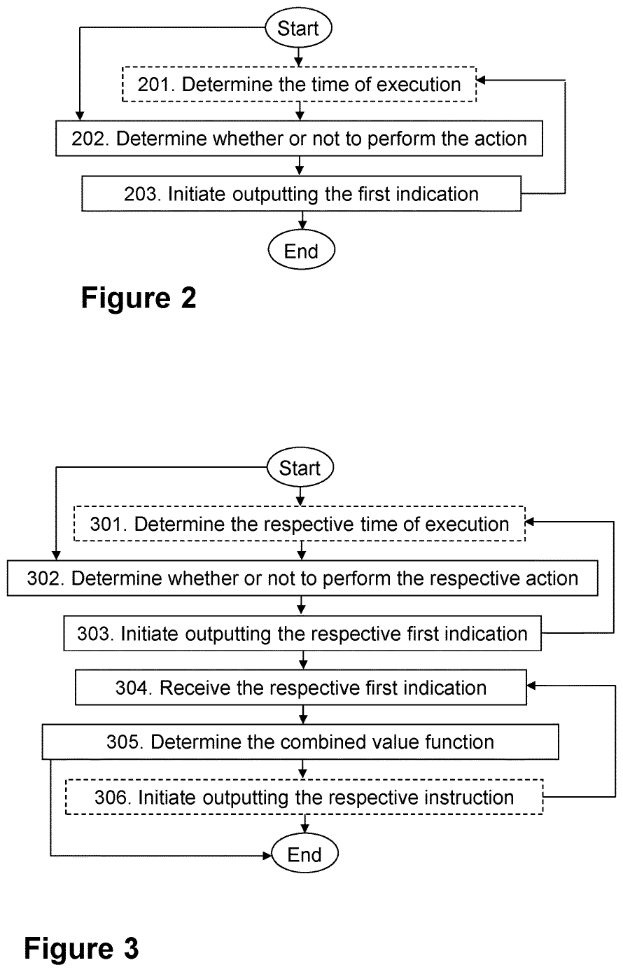

Embodiments of a computer-implemented method, performed by the first node 111, will now be described with reference to the flowchart depicted in FIG. 2. The first node 111 has a capability to perform RL in coordination with the one or more additional nodes 112,113, e.g., to perform MARL. The method is for handling the RL in the computer system 100. The first node 111 may operate in the computer system 100.

Several embodiments are comprised herein. In some embodiments all the actions may be performed. In some embodiments, some actions may be optional. In FIG. 2, an optional action is indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

### Action 201

In this Action 201, the first node 111 may determine a time of execution, e.g., t. The time of execution may be understood to be the time at which an action, e.g., in an RL procedure, is to be performed, in response to a state, e.g., sᵢ, in an environment. The RL procedure may be understood to be in coordination with the one or more additional nodes 112,113. That is, the RL procedure may be a MARL.

As stated earlier, the RL procedure may use one of: the QMIX procedure, the Implicit Q-Learning procedure, the MAVEN procedure and the VDN. In some embodiments, each of the first node 111 and the one or more additional nodes 112,113 may be represented by the three layer RNN.

The determining in this Action 201 may be understood as calculating, deriving or detecting.

The time of execution is determined dynamically.

The time of execution may be at least one of the following options: a) the time of execution may be different from another time of execution used during a training phase of the RL procedure, b) event-based, c) the same for the first node 111 and all the one or more additional nodes 112,113, and d) different for the first node 111 and all the one or more additional nodes 112,113.

By determining the time of execution in this Action 201, dynamically, the first node 111 may then be enabled to use the determined time of execution in the next Action 202, in order to determine whether or not to perform an action in the RL procedure. By performing the determination of whether or not to perform an action with the dynamically determined time or execution, the first node 111 may enable to perform event-based actuations. That is, actuations if and only if some change happens. This may be understood to be in contrast to existing methods, which as explained earlier, may assume the execution time-step may be the same time-step as that used during training. In many cases, as explained earlier, it may be beneficial to perform only event-based actuations.

### Action 202

In this Action 202, the first node 111 determines, in the RL procedure, whether or not to perform the action, in response to the state in the environment, at the time of execution. The determining in this Action 202 of whether or not to perform the action may be based on the determined time of execution. As stated above, the time of execution is determined dynamically in Action 201.

Particularly, in this Action 202, the time of execution may be used in a computation of a value function in the RL.

A value function, e.g., of a particular state, may be understood as an indication of how good it may be for an agent to be in a given state.

In order to perform event-based actuations, embodiments herein may include the time of execution in the computation of the value function. In some embodiments, the value function may be a Q-value. A Q-value may be understood to be used to estimate how good taking an action may be, given a certain state where the goal may be understood to be to obtain an action which may have a high Q-value. In order to perform these event-based actuations, embodiments herein may include the time of execution in the Q-value function so that the agents, that is, the first node 111 and the one or more additional nodes 112, 113, may be generalized to any time aspect.

For the sake of simplifying the explanation, embodiments herein may be described herein using a value decomposition method. A value decomposition method may be understood as a type of method to learn collaboration between agents in a MARL setting. Embodiments herein may be understood to introduce time as a another parameter during agent action, in order to get an optimal Q-value in MARL. To illustrate this with an example, a scenario may be assumed where there may be N agents in the computer system 100, where each agent may be trained with combined value functions. A combined value function may be understood as an estimate of goodness of a state when a joint action of all the agents may be applied. The combined value function may be obtained by:

$${Q}_{tot} = {\sum }_{i = 1}^{N} {Q}_{i} ( τ , a )$$

where τ may be understood to be the individual history of the agents, and a may be understood to be an action taken by the agent ‘i’. In VDN, the agents may be trained with the loss function:

$${L}_{B} = {‖ {r}_{t} + γ {Q}_{i} ( {τ}_{t + 1} , a ) - {Q}_{tot} ‖}_{2}^{2}$$

where rₜ may be understood as a reward obtained from the environment after applying the joint action.

The loss function may be understood to measure a difference between an estimated value function of the state and a value obtained from the real environment. The loss function may be minimized over a B batch of the samples, that is, B samples of data collected from the environment. During execution, the agents may execute in a decentralized environment, where the goal may be understood to be to obtain an action which may have a high Q-value. That is, to maximize the Q-value for a given state, as represented by the following formula:

$${a}_{i} = {}_{a}^{max} Q ( {s}_{i} , a )$$

where sᵢ may be understood to be the state of the environment observed by agent i.

To make the training dependent on time, according to embodiments herein, the Q-value of each agent may be made dependent on the time. That is, Q may be calculated as a function of state, action and time, as indicated in the following formula.

Qᵢ=fᵢ(sᵢ,a,t,τᵢ)

That is, according to embodiments herein, the Q-value of the first node 111 as agent i may be computed as:

Qᵢ=fᵢ(sᵢ,a,t,τᵢ)

In such calculation, sᵢ may be understood as the state of the environment, observed by the agent i, τ may be understood as an individual history of actions and respective resulting states and respective rewards of the agent i, a may be understood as the action taken by the agent i, and t may be understood as the time of execution.

The Q_total value, may then be calculated. in some embodiments, a Qₜₒₜ value for the first node 111 and the one or more additional nodes 112,113 may be calculated as:

$${Q}_{tot} = {\sum }_{i = 1}^{N} {α}_{i} {Q}_{i} ( {τ}_{i} , a , t )$$

where

$${α}_{i} = \frac{{t}_{i}}{max ( {t}_{i} ) , i = 1 , … N}$$

The factor αᵢ may be used in the calculation of Qₜₒₜₐₗ, in order to scale each Q-value according to the time it may have obtained versus the maximum time for an agent to get the observation, that is, the state of the system.

According to the foregoing, in some embodiments, the Q-value may be scaled according to the time of execution with respect to a maximum time that may be needed by the first node 111 to obtain an observation on the state.

During execution, the first node 111 may also include time by which one may obtain the action for an agent i in a calculation of:

$${a}_{i} = {}_{a}^{max} Q ( {s}_{i} , a , {t}_{i} )$$

where tᵢ may be understood to be the execution time of the agent i. This calculation may be used to select the best action out of all possible actions during execution.

In many cases, as explained earlier, it may be beneficial to perform only event-based actuations. By in this Action 202, performing the determination of whether or not to perform an action with the dynamically determined time or execution, the first node 111 may enable to perform event-based actuations. That is, actuations if and only if some change happens. As stated earlier, this may be understood to be in contrast to existing methods, which may assume the execution time-step may be the same time-step as that used during training. To illustrate this with an example, a scenario may be considered where a set of MARL agents which may control driver-less vehicles may be trained. These vehicles may measure state information from the network, such as information on nearby vehicles, and use these states to decide on the action to take. The network QoS may change depending on the number of nearby vehicles, network capacity etc. When the network QoS decreases, it may result in a significant packet loss due to network congestion. If the agents were trained with fixed time actuations, as they would in existing methods, it may hinder the execution performance between the agents, as the agents may need to take a decision when they may have predicted degradation of QoS, not when it may actually happen, due to the time-step resolution. When the MARL may train with fixed time actuations, the performance of the agents may not be optimal and/or agents may miss good state information. Embodiments herein may relate to a MARL system which may take event-based actuations to ensure the agents may behave optimally and take actions when they may have good state information.

### Action 203

In this Action 203, the first node 111 initiates outputting a first indication of a result of the determination. That is, a respective first indication of the first node 111.

The initiating outputting in this Action 203 may comprise triggering the output, enabling the output, providing the output on an interface or sending the output to another node comprised in the computer system 100.

In some embodiments, the initiating, in this Action 203, outputting the first indication may comprise at least one of the following. In some embodiments, sending the first indication to the second node 122 operating in the computer system 100. In such embodiments, the first indication may indicate the computed value function in the RL. For example, the first indication may be, e.g., Q_{N}(s, a, t)αN.

In some embodiments, initiating outputting the first indication may comprise outputting an instruction to perform the action based on the result of the determination.

By initiating outputting the first indication in this Action 203, the first node 111 may then be enabled to trigger event-based actuations, to ensure the first node 111 may behave optimally and take actions when it may have good state information. Since the first node 111 may perform RL in coordination with the one or more additional nodes 112,113, by initiating outputting the first indication in this Action 203, the first node 111 may also enable to trigger event-based actuations, to ensure the first node 111 in coordination with the one or more additional nodes 112,113, may behave optimally and take actions when they may have good state information.

Embodiments of a computer-implemented method, performed by the computer system 100, will now be described with reference to the flowchart depicted in FIG. 3. The computer system 100 comprises the first node 111 and the one or more additional nodes 112,113. The first node 111 and the one or more additional nodes 112,113 have the capability to perform RL in coordination. The method is for handling the RL in the computer system 100.

Several embodiments are comprised herein. In some embodiments all the actions may be performed. In some embodiments, some actions may be optional. In FIG. 3, an optional action is indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the first node 111 and will thus not be repeated here. For example, the RL in coordination of the first node 111 with the one or more additional nodes 112,113 may be the multi-agent RL procedure.

### Action 301

In this Action 301, the computer system 100 may determine, by each of the first node 111 and the one or more additional nodes 112,113, a respective time of execution, e.g., t. The RL procedure may be understood to be in coordination of the first node 111 with the one or more additional nodes 112,113. That is, the RL procedure may be a MARL.

As stated earlier, the RL procedure may use one of: the QMIX procedure, the Implicit Q-Learning procedure, the MAVEN procedure and the VDN. In some embodiments, each of the first node 111 and the one or more additional nodes 112,113 may be represented by the three layer RNN.

The determining in this Action 301 may be understood as calculating, deriving or detecting.

Respective may be understood in relation to this method, as pertaining to one of the nodes.

The respective time of execution is determined dynamically.

The respective time of execution may be at least one of the following options: a) different from another respective time of execution used, by each of the first node 111 and the one or more additional nodes 112,113, during the training phase of the RL procedure, b) event-based, c) the same for the first node 111 and all the one or more additional nodes 112,113, and d) different for the first node 111 and all the one or more additional nodes 112,113.

### Action 302

In this Action 302, the computer system 100 determines, by each of the first node 111 and the one or more additional nodes 112,113, in the RL procedure, whether or not to perform a respective action, in response to a respective state in the environment, at the respective time of execution. The determining in this Action 302 of whether or not to perform the respective action may be based on the determined respective time of execution. As stated above, the respective time of execution is determined dynamically in Action 301.

Particularly, in this Action 302, the respective time of execution may be used in a respective computation of a respective value function in the RL.

The respective value function may be a respective Q-value. In some embodiments, the respective time of execution may be used in a respective computation of the respective Q-value.

That is, according to embodiments herein, the respective Q-value for each of the first node 111 and the one or more additional nodes 112,113, as agent i may be computed as:

Qᵢ=fᵢ(sᵢ,a,t,τ₁)

Each of the first node 111 and the one or more additional nodes 112, 113 may be understood as an agent.

In such calculation, sᵢ may be understood as the respective state of the environment, observed by the agent i, τ may be understood as an individual history of respective actions and respective resulting states and respective rewards of the agent i, a may be understood as the respective action taken by the agent i, and t may be understood as the respective time of execution.

In some embodiments, the respective Q-value may be scaled according to the respective time of execution with respect to a respective maximum time that may be needed by each of the first node 111 and the one or more additional nodes 112,113 to obtain a respective observation on the respective state.

### Action 303

In this Action 303, the computer system 100 initiates, by each of the first node 111 and the one or more additional nodes 112,113 outputting a respective first indication of a respective result of the respective determination performed in Action 302. That is, the determination of whether or not to perform the respective action, in response to the respective state in the environment, at the respective time of execution.

The initiating outputting in this Action 303 may comprise triggering the output, enabling the output, providing the output on an interface or sending the output to another node comprised in the computer system 100.

In some embodiments, the initiating, in this Action 303, outputting the respective first indication may comprise at least one of the following. In some embodiments, sending, by each of the first node 111 and the one or more additional nodes 112,113, the respective first indication to the second node 122 operating in the computer system 100. In such embodiments, the respective first indication may indicate the respectively computed respective value function in the RL. For example, the respective first indication may be, e.g., Q_{N}(s, a, t)αN.

In some embodiments, initiating outputting the respective first indication may comprise outputting a respective instruction to perform the respective action based on the result of the determination.

### Action 304

In some embodiments, wherein the initiating 303 outputting the respective first indication may comprise sending, by each of the first node 111 and the one or more additional nodes 112,113, the respective first indication to the second node 122, the computer system 100 may comprise the second node 122. In some of such embodiments, in this Action 304, the computer system 100 may receive, by the second node 112, the respective first indication from each of the first node 111 and the one or more additional nodes 112,113.

### Action 305

In some of the embodiments, wherein the initiating 303 outputting the respective first indication may comprise sending, by each of the first node 111 and the one or more additional nodes 112,113, the respective first indication to the second node 122, and wherein the computer system 100 may comprise the second node 122, the computer system 100 may, in this Action 305, determine, by the second node 112, and based on the received respective first indications, a combined value function in the reinforcement learning procedure for the first node 111 and the one or more additional nodes 112,113.

In some embodiments, the combined value function is a Qₜₒₜ value for the first node 111 and the one or more additional nodes 112,113 calculated as:

$${Q}_{tot} = {\sum }_{i = 1}^{N} {α}_{i} {Q}_{i} ( {τ}_{i} , a , t )$$

where

$${α}_{i} = \frac{{t}_{i}}{max ( {t}_{i} ) , i = 1 , … N}$$

### Action 306

In this Action 306, the computer system 100 may initiates, by the second node 112, outputting a respective instruction to perform the respective action based on the determined combined value function.

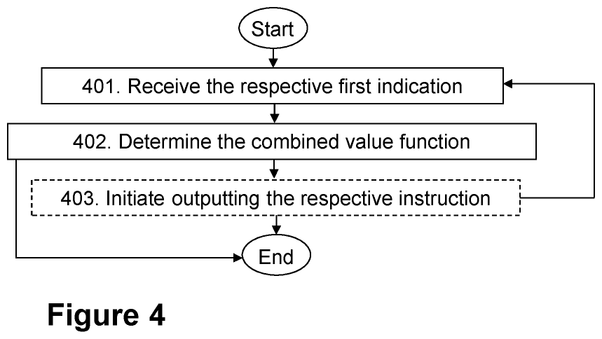

Embodiments of a computer-implemented method, performed by the second node 122, will now be described with reference to the flowchart depicted in FIG. 4. The method is for handling the RL in the computer system 100. The computer system 100 comprises the first node 111 and the one or more additional nodes 112,113. The first node 111 and the one or more additional nodes 112,113 have the capability to perform RL in coordination, e.g., to perform MARL. The second node 122 may operate in the computer system 100.

Several embodiments are comprised herein. In some embodiments all the actions may be performed. In some embodiments, some actions may be optional. In FIG. 4, an optional action is indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. For example, the RL in coordination of the first node 111 with the one or more additional nodes 112,113 may be the multi-agent RL procedure.

### Action 401

In this Action 401, the second node 122 receives, from each of the first node 111 and the one or more additional nodes 112,113, in the reinforcement learning procedure, the respective first indication. The respective first indication indicates the computed respective value function, that is, the respectively computed respective value function, in the reinforcement learning, to perform the respective action, in response to the respective state in the environment, at the respective time of execution. The respective time of execution is determined dynamically by each of the first node 111 and the one or more additional nodes 112,113.

As stated earlier, the RL procedure may use one of: the QMIX procedure, the Implicit Q-Learning procedure, the MAVEN procedure and the VDN. In some embodiments, each of the first node 111 and the one or more additional nodes 112,113 may be represented by the three layer RNN.

The respective time of execution may be at least one of the following options: a) different from the another respective time of execution used, by each of the first node 111 and the one or more additional nodes 112,113, during the training phase of the RL procedure, b) event-based, c) the same for the first node 111 and all the one or more additional nodes 112,113, and d) different for the first node 111 and all the one or more additional nodes 112,113.

In some embodiments, at least one of the following options may apply.

In a first option, the respective time of execution may have been used, by each of the first node 111 and the one or more additional nodes 112,113, in the respective computation of the respective value function in the RL.

In a second option, the respective time of execution may have been used by each of the first node 111 and the one or more additional nodes 112,113, in the respective computation of the respective Q-value.

In a third option, the respective Q-value for each of the first node 111 and the one or more additional nodes 112,113, as agent i may be computed as:

Qᵢ=fᵢ(sᵢ,a,t,τᵢ)

Each of the first node 111 and the one or more additional nodes 112, 113 may be understood as an agent.

In such calculation, sᵢ may be understood as the respective state of the environment, observed by the agent i, τ may be understood as the individual history of respective actions and respective resulting states and respective rewards of the agent i, a may be understood as the respective action taken by the agent i, and t may be understood as the respective time of execution.

### Action 402

In this Action 402, the second node 122 determines, based on the received respective first indications, the combined value function in the reinforcement learning procedure for the first node 111 and the one or more additional nodes 112,113.

In some embodiments, the combined value function may be a Qₜₒₜ value for the first node 111 and the one or more additional nodes 112,113 may be calculated as:

$${Q}_{tot} = {\sum }_{i = 1}^{N} {α}_{i} {Q}_{i} ( {τ}_{i} , a , t )$$

where

$${α}_{i} = \frac{{t}_{i}}{max ( {t}_{i} ) , i = 1 , … N}$$

The value tᵢ may be understood to be the respective time of execution of the agent i.

According to the foregoing, in some embodiments, the respective Q-value may be scaled according to the respective time of execution with respect to the respective maximum time that may be needed by each of the first node 111 and the one or more additional nodes 112,113 to obtain the respective observation on the respective state.

### Action 403

In this Action 403, the second node 122 initiates outputting the respective instruction to perform the respective action based on the determined combined value function.

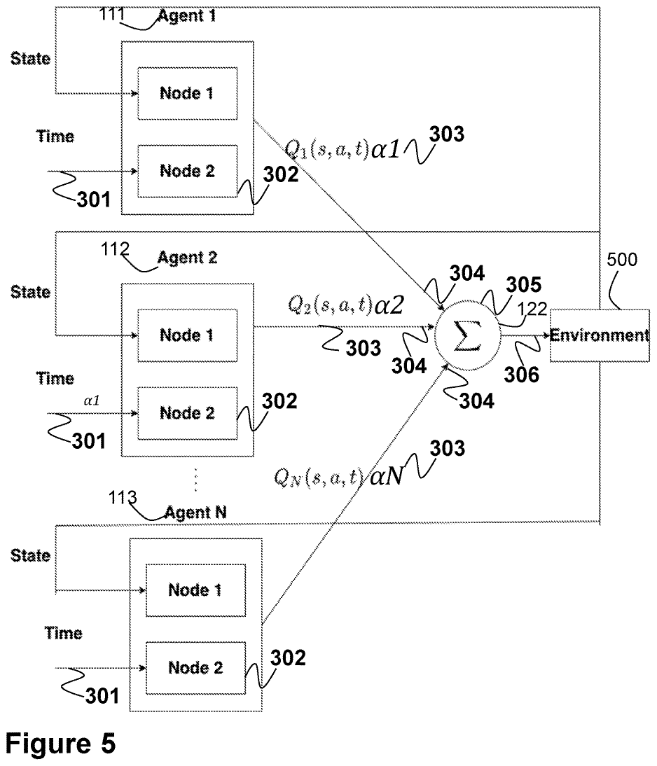

FIG. 5 is a schematic illustration depicting a non-limiting example of the method performed by the computer system 100 comprising the first node 111 and the one or more additional nodes 112, 113, as well as the second node 122. As depicted in FIG. 5, in a MARL procedure, the first node 111 is a first agent, Agent 1, the first additional node 112 is a second agent, Agent 2, and the second additional node is a third agent, Agent N. The dots represent that there may be more additional nodes in the computer system 100. Each of the agents has a respective Node 1 observing a state from the environment 500, and another node, Node 2, which may, according to Action 301, and Action 201, determine the respective time of execution “Time”. Each of the first node 111 and the one or more additional nodes 112, 113 may then, according to Action 302, and Action 202, determine whether or not to perform a respective action in the MARL procedure, in response to a respective state in the environment, at the respective time of execution. Then, each of the first node 111 and the one or more additional nodes 112, 113 may, according to Action 303 and Action 203, initiate outputting a respective first indication indicating a respective result of the respective determination. Particularly, the first node 111 may send the first indication Q₁(s, a, t)α1 to the second node 122, the first additional node 112 may send the first indication Q₂(s, a, t)α2 to the second node 122, and the second additional node 113 may send the first indication Q_{N}(s, a, t)αN to the second node 122. The second node 112 may receive the respective first indications from each of the first node 111 and the one or more additional nodes 112,113 according to Action 304 and 401. The second node 122 may then, according to Action 305 and 402, determine the combined value function in the MARL, and according to Action 306 and 403, output a respective instruction to perform the respective action on the environment 500, based on the determined combined value function.

### Test Conducted on Embodiments Herein

To test the approach followed by embodiments herein, the described methods were executed on a benchmark SMAC environment. For this, a 2s_3z map scenario was chosen in the SMAC environment.

### Training

At the start of training, the experiences were collected and stored in an experience buffer. To create these experiences, random actions were applied for every 1-10 seconds. To compare with the existing benchmark, the data was also collected by applying random actions for every 2 seconds. To train the collaboration between agents, a QMiX multi-agent RL method was used. Every agent value function was represented by a three-layer RNN network. Also, the mixing network was chosen by a two layer fully connected network. Each RNN network consisted of 44 input nodes and 1 output node. Also, the mixing network consisted of 5 input nodes followed by 1 output node. The agents were trained for 10,000 episodes for both cases.

### Execution

During execution, three different scenarios were considered:
1. The time of execution was the same as that used in training, for a fixed training time step of 2 seconds. This may be understood to correspond to a traditional QMIX with fixed training and execution time step.
2. The time of execution was chosen based on the distance of a target nearby for a training time step chosen randomly between 1-10 seconds. This may be understood to correspond to the approach of embodiments herein.
3. The time of execution was based on the distance of a target nearby for a training time step of 2 seconds. This may be understood to correspond to a traditional QMIX with different execution time step.

In the case of approach 2 and 3, the actions may be taken during execution either if the distance of the target is less than 4 a meter distance or the target took consecutive movements for previous time steps.

The averaged success rate and average number of actions per agent for each of the scenarios, for 100 episodes is shown in Table 1.

TABLE 1

| | | Average No. of actions |
|---|---|---|
| Approach | % Success Rate | per agent |
| 1 | 91.43 ± 3.14 | 899 |
| 2 | 95.31 ± 2.48 | 264 |
| 3 | 61.8 ± 6.01 | 281 |

From Table 1, as may be seen, the approach followed by embodiments herein obtained very good success rate when compared with the existing approach. Also, the approach followed by embodiments herein resulted in a lower number of actions when compared with existing methods. This may be understood to improve the overall life of hardware with efficient accuracy.

### Example of Embodiments Herein

The approach followed by embodiments herein may be understood to help in performing event-based actuations. An example is given next.

In this example, it may be assumed that there are three vehicles in the neighborhood, and based on data on neighboring cars, any car may need to take actions. The neighbouring car information may have to been obtained from the network as it may act as medium between the vehicles. Using the state information, it may be assumed that cars may take action for every one hour, assuming the network is good. If may then be assumed that one vehicle is predicted to enter areas where network QoS is predicted to go down. In this case, a car may be understood to have to take actuation before entering the area to ensure the car takes proper actions along with neighbouring cars, improving collaboration.

The approach followed by embodiments herein may then be used to take event-based actuations to ensure that the cars take good actions which may improve the entire collaboration. The replay buffer in this example is shown in Table 2 where S No may be understood to be Sample Number:

TABLE 2

| S. No | State | Action | Time |
|---|---|---|---|
| 1 | S1 | A1 | 1 |
| 2 | S2 | A2 | 0.5 |
| 3 | S1 | A2 | 2 |

Certain embodiments may provide one or more of the following technical advantage(s). Embodiments herein may result in efficient and more generalized agents that may execute in different time steps.

Embodiments herein may also advantageously result in an increased life of the hardware, as actions may be understood to not be fixed in time.

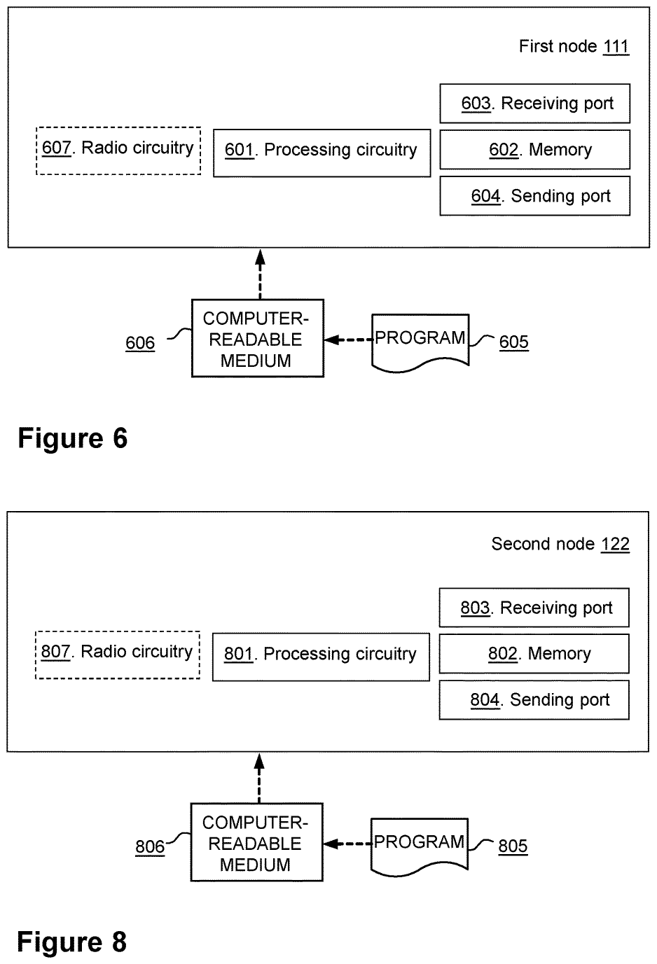

FIG. 6 depicts an example of the arrangement that the first node 111 may comprise to perform the method described in in FIG. 2 and/or FIG. 5. The first node 111 may be understood to be configured to have the capability to perform reinforcement learning in coordination with the one or more additional nodes 112,113. The first node 111 is configured to be for handling the reinforcement learning in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111, and will thus not be repeated here. For example, the reinforcement learning in coordination with the one or more additional nodes 112,113 may be configured to be the multi-agent reinforcement learning procedure.

The first node 111 is configured to determine, in the RL, whether or not to perform an action, in response to the state in the environment, at the time of execution. The time of execution is configured to be determined dynamically.

The first node 111 is also configured to initiate outputting the first indication of the result of the determination.

The first node 111 may be further configured to determine the time of execution. The determining of whether or not to perform the action may be configured to be based on the time of execution configured to be determined.

In some embodiments, the time of execution may be configured to be at least one of: a) different from another time of execution configured to be used during the training phase of the reinforcement learning procedure, b) event-based, c) the same for the first node 111 and all the one or more additional nodes 112,113, and d) different for the first node 111 and all the one or more additional nodes 112,113.

In some embodiments, at least one of the following may apply: a) the time of execution may be configured to be used in the computation of the value function in the reinforcement learning, b) the value function may be configured to be a Q-value, c) the Q-value of the first node 111 as agent i may be configured to be computed as:

Qᵢ=fᵢ(sᵢ,a,t,τᵢ)

wherein sᵢ may be configured to be the state of the environment, configured to be observed by the agent i, τ may be configured to be the individual history of actions and respective resulting states and respective rewards of the agent i, a may be configured to be the action taken by the agent i, and t may be configured to be the time of execution.

In some embodiments, the Q-value may be configured to be scaled according to the time of execution with respect to the maximum time configured to be needed by the first node 111 to obtain the observation on the state.

In some embodiments, a Qₜₒₜ value for the first node 111 and the one or more additional nodes 112,113 may be configured to be calculated as:

$${Q}_{tot} = {\sum }_{i = 1}^{N} {α}_{i} {Q}_{i} ( {τ}_{i} , a , t )$$

wherein

$${α}_{i} = \frac{{t}_{i}}{max ( {t}_{i} ) , i = 1 , … N}$$

In some embodiments, the initiating outputting the first indication may be configured to comprise at least one of: a) sending the first indication to the second node 122 configured to be operating in the computer system 100; the first indication may be configured to indicate the value function configured to be computed in the reinforcement learning, and b) outputting the instruction to perform the action based on the result of the determination.

In some embodiments, the reinforcement learning procedure may be configured to use one of: the QMIX procedure, the Implicit Q-Learning procedure, the MAVEN procedure and the VDN. Each of the first node 111 and the one or more additional nodes 112,113 may be configured to be represented by the three layer RNN.

The embodiments herein in the first node 111 may be implemented through one or more processors, such as a processing circuitry 601 in the first node 111 depicted in FIG. 6, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 602 comprising one or more memory units. The memory 602 is arranged to be used to store obtained information, store data, configurations, schedulings, and applications etc. to perform the methods herein when being executed in the first node 111.

In some embodiments, the first node 111 may receive information from, e.g., the one or more additional nodes 112, 113, the second node 112, the first radio network node 141, the first wireless device 131, and/or another structure in the wireless communications network 100, through a receiving port 603. In some embodiments, the receiving port 603 may be, for example, connected to one or more antennas in first node 111. In other embodiments, the first node 111 may receive information from another structure in the wireless communications network 100 through the receiving port 603. Since the receiving port 603 may be in communication with the processing circuitry 601, the receiving port 603 may then send the received information to the processing circuitry 601. The receiving port 603 may also be configured to receive other information.

The processing circuitry 601 in the first node 111 may be further configured to transmit or send information to e.g., the one or more additional nodes 112, 113, the second node 112, the first radio network node 141, the first wireless device 131, and/or another structure in the wireless communications network 100, through a sending port 604, which may be in communication with the processing circuitry 601, and the memory 602.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 601, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 601.

Thus, the methods according to the embodiments described herein for the first node 111 may be respectively implemented by means of a computer program 605 product, comprising instructions, i.e., software code portions, which, when executed on at least one processing circuitry 601, cause the at least one processing circuitry 601 to carry out the actions described herein, as performed by the first node 111. The computer program 605 product may be stored on a computer-readable storage medium 606. The computer-readable storage medium 606, having stored thereon the computer program 605, may comprise instructions which, when executed on at least one processing circuitry 601, cause the at least one processing circuitry 601 to carry out the actions described herein, as performed by the first node 111. In some embodiments, the computer-readable storage medium 606 may be a non-transitory computer-readable storage medium, such as a CD ROM disc, or a memory stick. In other embodiments, the computer program 605 product may be stored on a carrier containing the computer program 605 just described, wherein the carrier is one of an electronic signal, optical signal, radio signal, or the computer-readable storage medium 606, as described above.

The first node 111 may comprise a communication interface configured to facilitate, or an interface unit to facilitate, communications between the first node 111 and other nodes or devices, e.g., the one or more additional nodes 112, 113, the second node 112, the first radio network node 141, the first wireless device 131, and/or another structure in the wireless communications network 100. The interface may, for example, include a transceiver configured to transmit and receive radio signals over an air interface in accordance with a suitable standard.

In other embodiments, the first node 111 may comprise a radio circuitry 607, which may comprise e.g., the receiving port 603 and the sending port 604.

The radio circuitry 607 may be configured to set up and maintain at least a wireless connection with any of the one or more additional nodes 112, 113, the second node 112, the first radio network node 141, the first wireless device 131, and/or another structure in the wireless communications network 100. Circuitry may be understood herein as a hardware component.

Hence, embodiments herein also relate to the first node 111 operative to operate in the wireless communications network 100. The first node 111 may comprise the processing circuitry 601 and the memory 602, said memory 602 containing instructions executable by said processing circuitry 601, whereby the first node 111 is further operative to perform the actions described herein in relation to the first node 111, e.g., in FIG. 2 and/or FIG. 5.

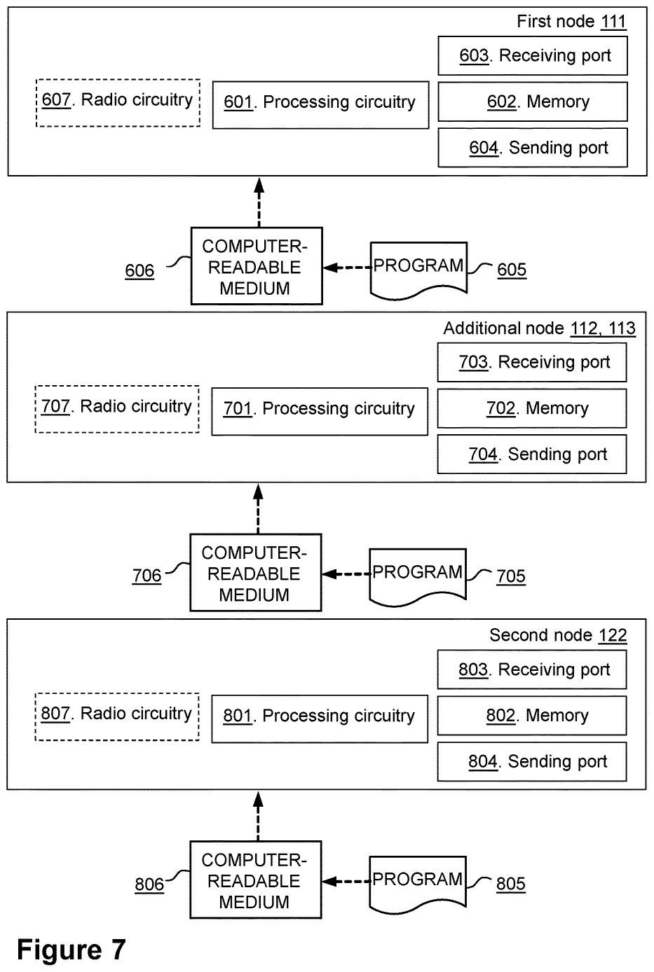

FIG. 7 depicts an example of the arrangement that the computer system 100 may comprise to perform the method described in FIG. 3 and/or FIG. 5. The computer system 100 may be configured to comprise the first node 111 and the one or more additional nodes 112,113. The first node 111 and the one or more additional nodes 112,113 may be configured to have the capability to perform reinforcement learning in coordination. The computer system 100 may be configured to be for handling the reinforcement learning in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the computer system 100, and will thus not be repeated here. For example, the reinforcement learning in coordination of the first node 111 with the one or more additional nodes 112,113 may be configured to be the multi-agent reinforcement learning procedure.

The computer system 100 is configured to determine, by each of the first node 111 and the one or more additional nodes 112,113, in a reinforcement learning procedure, whether or not to perform the respective action, in response to the respective state in the environment, at the respective time of execution. The respective time of execution is configured to be determined dynamically.

The computer system 100 is also configured to initiate, by each of the first node 111 and the one or more additional nodes 112,113, outputting the respective first indication configured to indicate the respective result of the respective determination.

The computer system 100 may be further configured to, determine, by each of the first node 111 and the one or more additional nodes 112,113, the respective time of execution. The determining of whether or not to perform the respective action may be configured to be based on the respective time of execution configured to be determined.

In some embodiments, the respective time of execution may be configured to be at least one of: a) different from another time of execution configured to be used, by each of the first node 111 and the one or more additional nodes 112,113, during the training phase of the reinforcement learning procedure, b) event-based, c) the same for the first node 111 and all the one or more additional nodes 112,113, and d) different for the first node 111 and all the one or more additional nodes 112,113.

In some embodiments, at least one of the following may apply: a) the respective time of execution may be configured to be used in the respective computation of the respective value function in the reinforcement learning, b) the respective time of execution may be configured to be used in the respective computation of the respective Q-value, c) the respective Q-value for each of the first node 111 and the one or more additional nodes 112,113, as agent i may be configured to be computed as:

Qᵢ=fᵢ(sᵢ,a,t,τ₁)

wherein sᵢ may be configured to be the state of the environment, configured to be observed by the agent i, τ may be configured to be the individual history of respective actions and respective resulting states and respective rewards of the agent i, a may be configured to be the respective action taken by the agent i, and t may be configured to be the respective time of execution.

In some embodiments, the respective Q-value may be configured to be scaled according to the respective time of execution with respect to the respective maximum time configured to be needed by each of the first node 111 and the one or more additional nodes 112,113 to obtain the respective observation on the respective state.

In some embodiments, the initiating outputting the respective first indication may be configured to comprise at least one of: a) sending, by each of the first node 111 and the one or more additional nodes 112,113, the respective first indication to the second node 122 configured to operate in the computer system 100; the respective first indication may be configured to indicate the respectively computed respective value function in the reinforcement learning, and b) outputting the respective instruction to perform the respective action based on the result of the determination.

In some embodiments wherein the initiating outputting the respective first indication may be configured to comprise sending, by each of the first node 111 and the one or more additional nodes 112,113, the respective first indication to the second node 122, the computer system 100 may be configured to comprise the second node 122. In some of such embodiments, the computer system 100 may be further configured to receive, by the second node 112, the respective first indication from each of the first node 111 and the one or more additional nodes 112,113.

In some embodiments, wherein the initiating outputting the respective first indication may be configured to comprise sending, by each of the first node 111 and the one or more additional nodes 112,113, the respective first indication to the second node 122, the computer system 100 may be configured to comprise the second node 122. In some of such embodiments, the computer system 100 may be further configured to determine, by the second node 112, and based on the respective first indications configured to be received, the combined value function in the reinforcement learning procedure for the first node 111 and the one or more additional nodes 112,113.

In some embodiments, wherein the initiating outputting the respective first indication may be configured to comprise sending, by each of the first node 111 and the one or more additional nodes 112,113, the respective first indication to the second node 122, the computer system 100 may be configured to comprise the second node 122. In some of such embodiments, the computer system 100 may be further configured to initiate, by the second node 112, outputting the respective instruction to perform the respective action based on the combined value function configured to be determined

In some embodiments, the combined value function may be configured to be the Qₜₒₜ value for the first node 111 and the one or more additional nodes 112,113 configured to be calculated as:

$${Q}_{tot} = {\sum }_{i = 1}^{N} {α}_{i} {Q}_{i} ( {τ}_{i} , a , t )$$

wherein

$${α}_{i} = \frac{{t}_{i}}{max ( {t}_{i} ) , i = 1 , … N}$$

In some embodiments, the reinforcement learning procedure may be configured to use one of: the QMIX procedure, the Implicit Q-Learning procedure, the MAVEN procedure and the VDN. Each of the first node 111 and the one or more additional nodes 112,113 may be configured to be represented by a three layer RNN.

In reference to the description of FIG. 7, it may be understood that the first node 111, comprised in the computer system 100, may comprise the arrangement to perform the method described in FIG. 3 and/or FIG. 5, as already described in relation to FIG. 6.

In reference to the description of FIG. 7, it may be understood that any of the one or more additional nodes 112, 113, comprised in the computer system 100, may comprise an arrangement to perform the method described in FIG. 3 and/or FIG. 5, as described next. A single additional node 112, 113 is depicted in FIG. 7 for illustration purposes. However, the description may be understood to apply to any of them.

The embodiments herein in the additional node 112, 113 may be implemented through one or more processors, such as a processing circuitry 701 in the additional node 112, 113 depicted in FIG. 7, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the additional node 112, 113. One such carrier may be in the form of a CD ROM disc. It is however feasible with other data carriers such as a memory stick. The computer program code may furthermore be provided as pure program code on a server and downloaded to the additional node 112, 113.

The additional node 112, 113 may further comprise a memory 702 comprising one or more memory units. The memory 702 is arranged to be used to store obtained information, store data, configurations, schedulings, and applications etc. to perform the methods herein when being executed in the additional node 112, 113.

In some embodiments, the additional node 112, 113 may receive information from, e.g., the first wireless device 131, the second wireless device 132, the third wireless device 133, the first radio network node 141, the second radio network node 142, the third radio network node 143, the first node 111, the other one or more additional nodes 112, 113, the second node 122 and/or another structure in the wireless communications network 100, through a receiving port 703. In some embodiments, the receiving port 703 may be, for example, connected to one or more antennas in additional node 112, 113. In other embodiments, the additional node 112, 113 may receive information from another structure in the wireless communications network 100 through the receiving port 703. Since the receiving port 703 may be in communication with the processing circuitry 701, the receiving port 703 may then send the received information to the processing circuitry 701. The receiving port 703 may also be configured to receive other information.

The processing circuitry 701 in the additional node 112, 113 may be further configured to transmit or send information to e.g., the first wireless device 131, the second wireless device 132, the third wireless device 133, the first radio network node 141, the second radio network node 142, the third radio network node 143, the first node 111, the other one or more additional nodes 112, 113, the second node 122 and/or another structure in the wireless communications network 100, through a sending port 704, which may be in communication with the processing circuitry 701, and the memory 702.

Those skilled in the art will also appreciate that the units comprised within the additional node 112, 113 described above as being configured to perform different actions, may refer to a combination of analog and digital circuits, and/or one or more processors configured with software and/or firmware, e.g., stored in memory, that, when executed by the one or more processors such as the processing circuitry 701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the additional node 112, 113 described above as being configured to perform different actions described above may be implemented as one or more applications running on one or more processors such as the processing circuitry 701.

Thus, the methods according to the embodiments described herein for the additional node 112, 113 may be respectively implemented by means of a computer program 705 product, comprising instructions, i.e., software code portions, which, when executed on at least one processing circuitry 701, cause the at least one processing circuitry 701 to carry out the actions described herein, as performed by the additional node 112, 113. The computer program 705 product may be stored on a computer-readable storage medium 706. The computer-readable storage medium 706, having stored thereon the computer program 705, may comprise instructions which, when executed on at least one processing circuitry 701, cause the at least one processing circuitry 701 to carry out the actions described herein, as performed by the additional node 112, 113. In some embodiments, the computer-readable storage medium 706 may be a non-transitory computer-readable storage medium, such as a CD ROM disc, or a memory stick. In other embodiments, the computer program 705 product may be stored on a carrier containing the computer program 705 just described, wherein the carrier is one of an electronic signal, optical signal, radio signal, or the computer-readable storage medium 706, as described above.

The additional node 112, 113 may comprise a communication interface configured to facilitate, or an interface unit to facilitate, communications between the additional node 112, 113 and other nodes or devices, e.g the first wireless device 131, the second wireless device 132, the third wireless device 133, the first radio network node 141, the second radio network node 142, the third radio network node 143, the first node 111, the other one or more additional nodes 112, 113, the second node 122 and/or another structure in the wireless communications network 100. The interface may, for example, include a transceiver configured to transmit and receive radio signals over an air interface in accordance with a suitable standard.

In other embodiments, the additional node 112, 113 may comprise a radio circuitry 707, which may comprise e.g., the receiving port 703 and the sending port 704.

The radio circuitry 707 may be configured to set up and maintain at least a wireless connection with any of the first wireless device 131, the second wireless device 132, the third wireless device 133, the first radio network node 141, the second radio network node 142, the third radio network node 143, the first node 111, the other one or more additional nodes 112, 113, the second node 122 and/or another structure in the wireless communications network 100. Circuitry may be understood herein as a hardware component.

Hence, embodiments herein also relate to the additional node 112, 113 operative to comprise the first node 111 and the one or more additional nodes 112. The additional node 112, 113 may comprise the processing circuitry 701 and the memory 702, said memory 702 containing instructions executable by said processing circuitry 701, whereby the additional node 112, 113 is further operative to perform the actions described herein in relation to the additional node 112, 113, e.g., in FIG. 3 and/or FIG. 5.

In reference to the description of FIG. 7, it may be understood that the second node 112, comprised in the computer system 100, may comprise the arrangement to perform the method described in FIG. 3 and/or FIG. 5, as described next, in relation to FIG. 8.

FIG. 8 depicts an example of the arrangement that the second node 122 may comprise to perform the method described in FIG. 4 and/or FIG. 5. The second node 122 may be understood to be for handling the reinforcement learning in the computer system 100. The computer system 100 may be configured to comprise the first node 111 and the one or more additional nodes 112,113. The first node 111 and the one or more additional nodes 112,113 may have the capability to perform reinforcement learning in coordination.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 122, and will thus not be repeated here. For example, the reinforcement learning in coordination of the first node 111 with the one or more additional nodes 112,113 may be configured to be the multi-agent reinforcement learning procedure.

The second node 122 is configured to receive, from each of the first node 111 and the one or more additional nodes 112,113, in the reinforcement learning procedure, the respective first indication. The respective first indication may be configured to indicate the computed respective value function in the reinforcement learning, to perform the respective action, in response to the respective state in the environment, at the respective time of execution. The respective time of execution may be configured to be determined dynamically by each of the first node 111 and the one or more additional nodes 112,113.

The second node 122 is also configured to determine, based on the received respective first indications, the combined value function in the reinforcement learning procedure for the first node 111 and the one or more additional nodes 112,113.

The second node 122 may be further configured to initiate outputting the respective instruction to perform the respective action based on the combined value function configured to be determined.

In some embodiments, at least one of the following may apply: a) the respective time of execution may be configured to be used, by each of the first node 111 and the one or more additional nodes 112,113, in the respective computation of the respective value function in the reinforcement learning, b) the respective time of execution may be configured to be used, by each of the first node 111 and the one or more additional nodes 112,113, in the respective computation of the respective Q-value, c) the respective Q-value for each of the first node 111 and the one or more additional nodes 112,113, as agent i may be configured to be computed as:

Qᵢ=fᵢ(sᵢ,a,t,τᵢ)

wherein sᵢ may be configured to be the respective state of the environment, configured to be observed by the agent I, τ may be configured to be the individual history of respective actions and respective resulting states and respective rewards of the agent i, a may be configured to be the respective action taken by the agent i, and t may be configured to be the respective time of execution.

In some embodiments, the respective time of execution may be configured to be at least one of: a) different from another respective time of execution configured to be used, by each of the first node 111 and the one or more additional nodes 112,113, during the training phase of the reinforcement learning procedure, b) event-based, c) the same for the first node 111 and all the one or more additional nodes 112,113, and d) different for the first node 111 and all the one or more additional nodes 112,113.

In some embodiments, the respective Q-value may be configured to be scaled according to the respective time of execution with respect to the respective maximum time configured to be needed by each of the first node 111 and the one or more additional nodes 112,113 to obtain the respective observation on the respective state.

In some embodiments, the combined value function may be configured to be the Qₜₒₜ value for the first node 111 and the one or more additional nodes 112,113 and may be configured to be calculated as:

$${Q}_{t o t} = {\sum }_{i = 1}^{N} {α}_{i} {Q}_{i} ( {τ}_{i} , a , t )$$

wherein

$${α}_{i} = \frac{{t}_{i}}{max ( {t}_{i} ) , i = 1 , … N}$$

In some embodiments, the reinforcement learning procedure may be configured to use one of: the QMIX procedure, the Implicit Q-Learning procedure, the MAVEN procedure and the VDN. Each of the first node 111 and the one or more additional nodes 112,113 may be configured to be represented by a three layer RNN.

The embodiments herein in the second node 122 may be implemented through one or more processors, such as a processing circuitry 801 in the second node 122 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 122. One such carrier may be in the form of a CD ROM disc. It is however feasible with other data carriers such as a memory stick. The computer program code may furthermore be provided as pure program code on a server and downloaded to the second node 122.

The second node 122 may further comprise a memory 802 comprising one or more memory units. The memory 802 is arranged to be used to store obtained information, store data, configurations, schedulings, and applications etc. to perform the methods herein when being executed in the second node 122.

In some embodiments, the second node 122 may receive information from, e.g., the first wireless device 131, the second wireless device 132, the third wireless device 133, the first radio network node 141, the second radio network node 142, the third radio network node 143, the first node 111, the other one or more additional nodes 112, 113, and/or another structure in the wireless communications network 100, through a receiving port 803. In some embodiments, the receiving port 803 may be, for example, connected to one or more antennas in second node 122. In other embodiments, the second node 122 may receive information from another structure in the wireless communications network 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the second node 122 may be further configured to transmit or send information to e.g., the first wireless device 131, the second wireless device 132, the third wireless device 133, the first radio network node 141, the second radio network node 142, the third radio network node 143, the first node 111, the other one or more additional nodes 112, 113, and/or another structure in the wireless communications network 100, through a sending port 804, which may be in communication with the processing circuitry 801, and the memory 802.

Those skilled in the art will also appreciate that the units comprised within the second node 122 described above as being configured to perform different actions, may refer to a combination of analog and digital circuits, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 122 described above as being configured to perform different actions described above may be implemented as one or more applications running on one or more processors such as the processing circuitry 801.

Thus, the methods according to the embodiments described herein for the second node 122 may be respectively implemented by means of a computer program 805 product, comprising instructions, i.e., software code portions, which, when executed on at least one processing circuitry 801, cause the at least one processing circuitry 801 to carry out the actions described herein, as performed by the second node 122. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the second node 122. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The second node 122 may comprise a communication interface configured to facilitate, or an interface unit to facilitate, communications between the second node 122 and other nodes or devices, e.g., the first wireless device 131, the second wireless device 132, the third wireless device 133, the first radio network node 141, the second radio network node 142, the third radio network node 143, the first node 111, the other one or more additional nodes 112, 113, and/or another structure in the wireless communications network 100. The interface may, for example, include a transceiver configured to transmit and receive radio signals over an air interface in accordance with a suitable standard.

In other embodiments, the second node 122 may comprise a radio circuitry 807, which may comprise e.g., the receiving port 803 and the sending port 804.

The radio circuitry 807 may be configured to set up and maintain at least a wireless connection with any of the first wireless device 131, the second wireless device 132, the third wireless device 133, the first radio network node 141, the second radio network node 142, the third radio network node 143, the first node 111, the other one or more additional nodes 112, 113, and/or another structure in the wireless communications network 100. Circuitry may be understood herein as a hardware component.

Hence, embodiments herein also relate to the second node 122 operative to operate in the wireless communications network 100. The second node 122 may comprise the processing circuitry 801 and the memory 802, said memory 802 containing instructions executable by said processing circuitry 801, whereby the second node 122 is further operative to perform the actions described herein in relation to the second node 122, e.g., in FIG. 4 and/or FIG. 5.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

[1] Sunehag, Peter, Guy Lever, Audrunas Gruslys, Wojciech Marian Czarnecki, Vinicius Zambaldi, Max Jaderberg, Marc Lanctot et al. “Value-decomposition networks for cooperative multi-agent learning.” arXiv preprint arXiv:1706.05296 (2017).
[2] Menda, Kunal, Yi-Chun Chen, Justin Grana, James W. Bono, Brendan D. Tracey, Mykel J. Kochenderfer, and David Wolpert. “Deep RL for event-driven multi-agent decision processes.” IEEE Transactions on Intelligent Transportation Systems 20, no. 4 (2018): 1259-1268.
[3] Tang, Hongyao, Jianye Hao, Tangjie Lv, Yingfeng Chen, Zongzhang Zhang, Hangtian Jia, Chunxu Ren et al. “Hierarchical deep multiagent RL with temporal abstraction.” arXiv preprint arXiv:1809.09332 (2018).

1-56. (canceled)

57. A computer-implemented method, performed by a first node, the first node having a capability to perform reinforcement learning in coordination with one or more additional nodes, the method being for handling the reinforcement learning in a computer system, the method comprising:
determining, in a reinforcement learning procedure, whether or not to perform an action, in response to a state in an environment, at a time of execution, wherein the time of execution is determined dynamically; and
initiating outputting a first indication of a result of the determination.

58. A computer-implemented method, performed by a computer system, the computer system comprising a first node and one or more additional nodes, the first node and the one or more additional nodes having a capability to perform reinforcement learning in coordination, the method being for handling the reinforcement learning in the computer system, the method comprising:
determining, by each of the first node and the one or more additional nodes, in a reinforcement learning procedure, whether or not to perform a respective action, in response to a respective state in an environment, at a respective time of execution, wherein the respective time of execution is determined dynamically; and
initiating, by each of the first node and the one or more additional nodes, outputting a respective first indication indicating a respective result of the respective determination.

59. The method according to claim 58, further comprising:
determining, by each of the first node and the one or more additional nodes, the respective time of execution, and wherein the determining of whether or not to perform the respective action is based on the determined respective time of execution.

60. The method according to claim 58, wherein the respective time of execution is at least one of:
a. different from another respective time of execution used, by each of the first node and the one or more additional nodes, during a training phase of the reinforcement learning procedure,
b. event-based,
c. the same for the first node and all the one or more additional nodes, and
d. different for the first node and all the one or more additional nodes.

61. The method according to claim 58, wherein at least one of:
the respective time of execution is used in a respective computation of a respective value function in the reinforcement learning;
the respective time of execution is used in a respective computation of a respective Q-value; or
the respective Q-value for each of the first node and the one or more additional nodes, as agent i is computed as:
Qᵢ=fᵢ(sᵢ,a,t,τᵢ)
wherein sᵢ is the respective state of the environment, observed by the agent i,
τ is an individual history of respective actions and respective resulting states and respective rewards of the agent i,
a is the respective action taken by the agent i, and
t is the respective time of execution.

62. The method according to claim 61, wherein the respective Q-value is scaled according to the respective time of execution with respect to a respective maximum time needed by each of the first node and the one or more additional nodes to obtain a respective observation on the respective state.

63. The method according to claim 58, wherein the initiating outputting the respective first indication comprises at least one of:
a. sending, by each of the first node and the one or more additional nodes, the respective first indication to a second node operating in the computer system, the respective first indication indicating the respectively computed respective value function in the reinforcement learning, and
b. outputting a respective instruction to perform the respective action based on the result of the determination.

64. The according to claim 63, wherein the initiating outputting the respective first indication comprises sending, by each of the first node and the one or more additional nodes, the respective first indication to the second node, wherein the computer system comprises the second node, and wherein the method further comprises:
receiving, by the second node, the respective first indication from each of the first node and the one or more additional nodes, and
determining, by the second node, and based on the received respective first indications, a combined value function in the reinforcement learning procedure for the first node and the one or more additional nodes.

65. The method according to claim 64, further comprising:
initiating, by the second node, outputting a respective instruction to perform the respective action based on the determined combined value function.

66. The method according to claim 64, wherein the combined value function is a Qₜₒₜ value for the first node and the one or more additional nodes calculated as:
$${Q}_{t o t} = {\sum }_{i = 1}^{N} {α}_{i} {Q}_{i} ( {τ}_{i} , a , t )$$
wherein
$${α}_{i} = \frac{{t}_{i}}{max ( {t}_{i} ) , i = 1 , … N} .$$

67. The method according to claim 58, wherein the reinforcement learning procedure uses one of:
a QMIX procedure;
an Implicit Q-Learning procedure;
a Multi-Agent Variational Exploration, MAVEN, procedure; or
a Value Decomposition Network, VDN; and
wherein each of the first node and the one or more additional nodes are represented by a three layer recurrent neural network, RNN.

68. The method according to claim 58, wherein the reinforcement learning in coordination of the first node with the one or more additional nodes is a multi-agent reinforcement learning procedure.

69. A computer-implemented method, performed by a second node, the method being for handling reinforcement learning in a computer system, the computer system comprising a first node and one or more additional nodes, the first node and the one or more additional nodes having a capability to perform reinforcement learning in coordination, the method comprising:
receiving, from each of the first node and the one or more additional nodes, in a reinforcement learning procedure, a respective first indication, the respective first indication indicating a computed respective value function in the reinforcement learning, to perform a respective action, in response to a respective state in an environment, at a respective time of execution, wherein the respective time of execution is determined dynamically by each of the first node and the one or more additional nodes; and
determining, based on the received respective first indications, a combined value function in the reinforcement learning procedure for the first node and the one or more additional nodes.

70. The method according to claim 69, further comprising:
initiating outputting a respective instruction to perform the respective action based on the determined combined value function.

71. The method according to claim 69, wherein the respective time of execution is at least one of:
a. different from another respective time of execution used, by each of the first node and the one or more additional nodes, during a training phase of the reinforcement learning procedure;
b. event-based;
c. the same for the first node and all the one or more additional nodes; or
d. different for the first node and all the one or more additional nodes.

72. The method according to claim 69, wherein at least one of:
the respective time of execution is used, by each of the first node and the one or more additional nodes, in a respective computation of the respective value function in the reinforcement learning;
the respective time of execution is used, by each of the first node and the one or more additional nodes, in a respective computation of a respective Q-value;
the respective Q-value for each of the first node and the one or more additional nodes, as agent i is computed as:
Qᵢ=fᵢ(sᵢ,a,t,τᵢ)
wherein sᵢ is the respective state of the environment, observed by the agent i,
τ is an individual history of respective actions and respective resulting states and respective rewards of the agent i,
a is the respective action taken by the agent i, and
t is the respective time of execution.

73. The method according to claim 72, wherein the respective Q-value is scaled according to the respective time of execution with respect to a respective maximum time needed by each of the first node and the one or more additional nodes to obtain a respective observation on the respective state.

74. The method according to claim 73, wherein the combined value function is a Qₜₒₜ value for the first node and the one or more additional nodes calculated as:
$${Q}_{t o t} = {\sum }_{i = 1}^{N} {α}_{i} {Q}_{i} ( {τ}_{i} , a , t )$$
wherein
$${α}_{i} = \frac{{t}_{i}}{max ( {t}_{i} ) , i = 1 , … N} .$$

75. The method according to claim 69, wherein the reinforcement learning procedure uses one of:
a QMIX procedure;
an Implicit Q-Learning procedure;
a Multi-Agent Variational Exploration, MAVEN, procedure; or
a Value Decomposition Network, VDN; and
wherein each of the first node and the one or more additional nodes are represented by a three layer recurrent neural network, RNN.

76. The method according to claim 69, wherein the reinforcement learning in coordination of the first node with the one or more additional nodes is a multi-agent reinforcement learning procedure.
